(19) United States
(12) Patent Application Publication
(10) Pub. No.: US 2003/0179969 A1
(43) Pub. Date: Sep. 25, 2003

(54) Bearing housing for ball bearing mechanical tranmission

(76) Inventor: Olivier Louis-Marie Baudry, Vaux Sur Seine (FR)

Correspondence Address: Robert P Renke John A Artz, Artz & Artz, Suite 250, 28333 Telegraph, Southfield, MI, 48034, US

(21) Appl. No.: 10/297,459

(22) PCT Filed: Apr. 9, 2002
(86) PCT No.: PCT/FR02/01241

(30) Foreign Application Priority Data
Apr. 9, 2001 (FR) 01 04817

(51) Int. Cl. F16C 43/00

(52) U.S. Cl. 384/537; 384/542

(57) ABSTRACT

The bearing block (20) is intended to support a mechanical transmission member comprising a rolling bearing (12). It comprises a fixing sole (22) and forms a bore (26) for supporting the rolling bearing, roughly coaxial with the rolling bearing, and a member (50) for clamping the bearing block onto the rolling bearing. The bore is formed by a clamping jaw (28) of one piece which on its periphery has a single open location (A).

Application to the support of front-wheel-drive motor vehicle transmission half-shafts.

The present invention relates to a bearing block intended to support a mechanical transmission member comprising a rolling bearing, of the type defined in the preamble of claim 1.

Such bearing blocks commonly equip the transmission shafts of the engines of motor vehicles. In particular, in many front-wheel-drive vehicles, such bearing blocks support the transverse half-shaft connecting the differential of the engine to the front wheel of the vehicle furthest from this differential. More specifically, in this case, the shaft is extended by a joint body, often known as a bell housing, designed to constitute the female element of a transmission joint, juxtaposed with the bearing block. The bell housing is secured to the shaft and formed integrally with it. The bearing block then supports a mechanical transmission member comprising the shaft, the bell housing integral with the shaft and the rolling bearing mounted either on this shaft or on the base of the bell housing.

Such bearing blocks generally consist of two independent parts. On the one hand, the base of the bearing block has a sole for fixing the bearing block to the engine block and a first jaw of which the profile in cross section is of roughly semicircular shape. On the other hand, whilst the rolling bearing and the bell housing have been positioned inside the half-cylinder delimited by this first jaw, it is necessary to attach a second jaw, also known as a cap. This second jaw is essential for holding the rolling bearing and the bell housing; it is fixed to the first jaw at least at two clamping points.

These bearing blocks therefore comprise a high number of parts and require twofold fixing. Given the space in the engine bays of current vehicles, access to these fixing points is difficult and clamping at least one of the two fixing points proves to be a complicated operation involving the use of special equipment.

Fine adjustment of the clamping is thereby compromised, even though it is of prime importance that the rolling bearing mounted on the shaft be clamped tightly enough to prevent it from shifting axially without it being in any way clamped excessively as this would cause it to lock completely.

The object of the invention is to propose a bearing block of the aforementioned type which can easily be positioned with respect to the mechanical transmission member and the clamping of which is obtained precisely and in a particularly simple way.

To this end, the subject of the invention is a bearing block of the aforementioned type having the characteristics of the characterizing part of claim 1.

According to some particular embodiments, the bearing block may have one or more of the characteristics defined in claims 2 to 13, taken in isolation or in any technically feasible combination.

The invention will be better understood from the description which will follow, given solely by way of example and made with reference to the appended drawings in which:

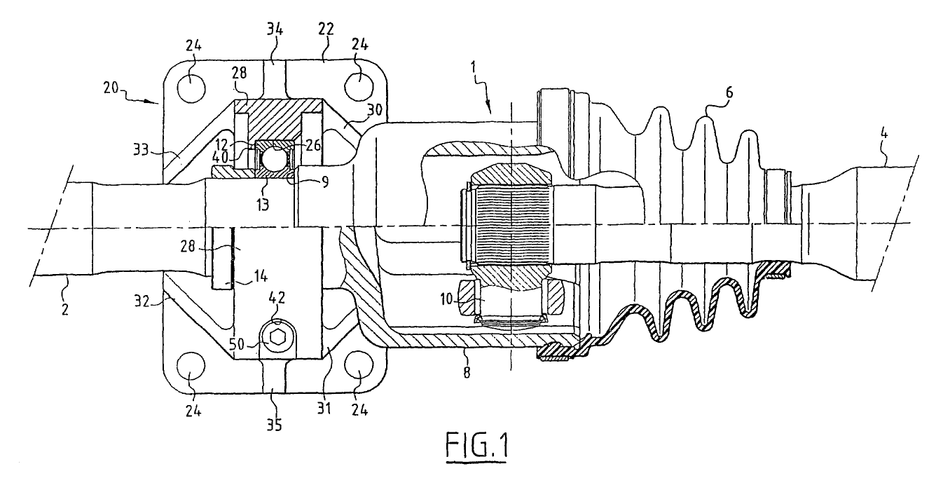

FIG. 1 is an overall view, partly in longitudinal section, of a joint connecting two shafts, one of which is provided with a rolling bearing and supported by a bearing block according to the invention;

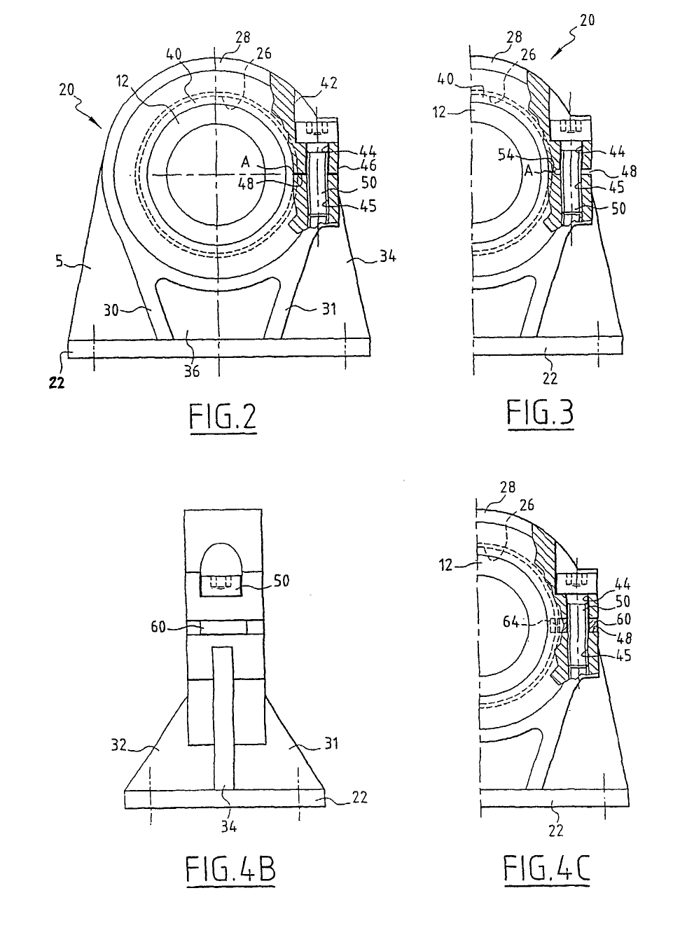

FIG. 2 is a front view, partly in section, of a bearing block according to the invention, provided with a rolling bearing;

FIG. 3 is a view similar to the right-hand half-view of FIG. 2, but of a bearing block according to another embodiment of the invention;

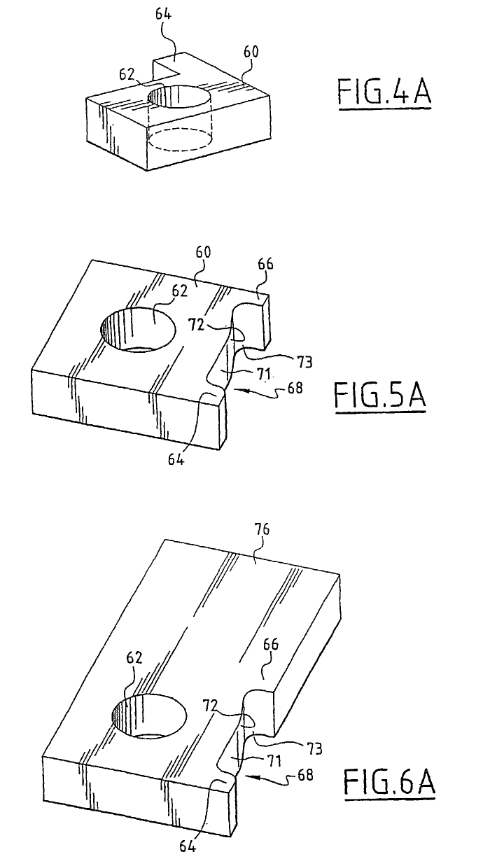

FIG. 4A is a perspective view of a wedge used in another embodiment of a bearing block according to the invention;

FIG. 4B is a side view of a bearing block according to the invention provided with the wedge depicted in FIG. 4A;

FIG. 4C is a view similar to FIG. 3 but of the bearing block depicted in FIG. 4B;

FIG. 5A is a view similar to FIG. 4A but of an alternative form of wedge;

FIGS. 5B to 5E are views in longitudinal section of a bearing block according to another embodiment of the invention, using the wedge of FIG. 5a, these figures illustrating respectively four successive steps in the slipping of a shaft provided with a rolling bearing into this bearing block;

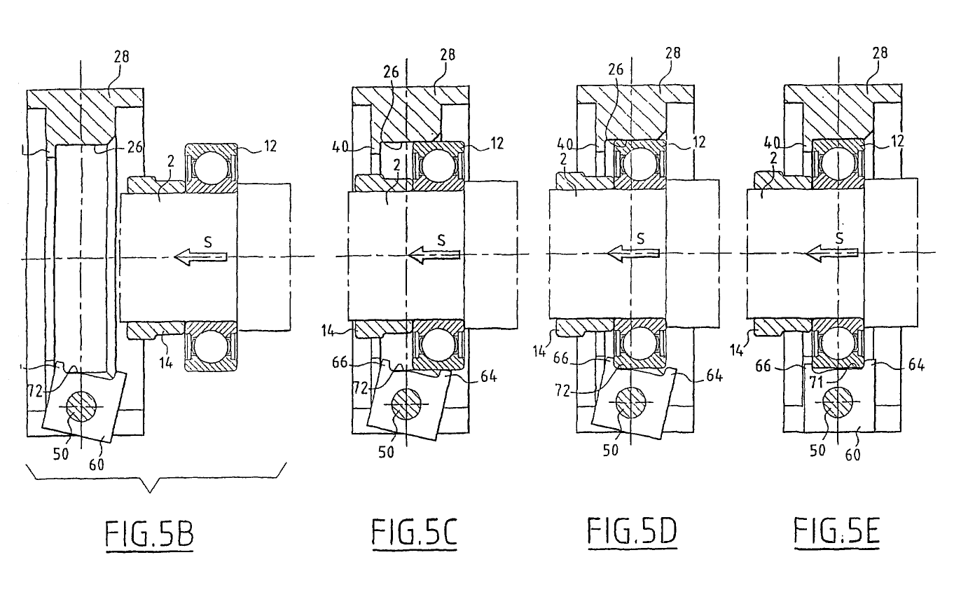

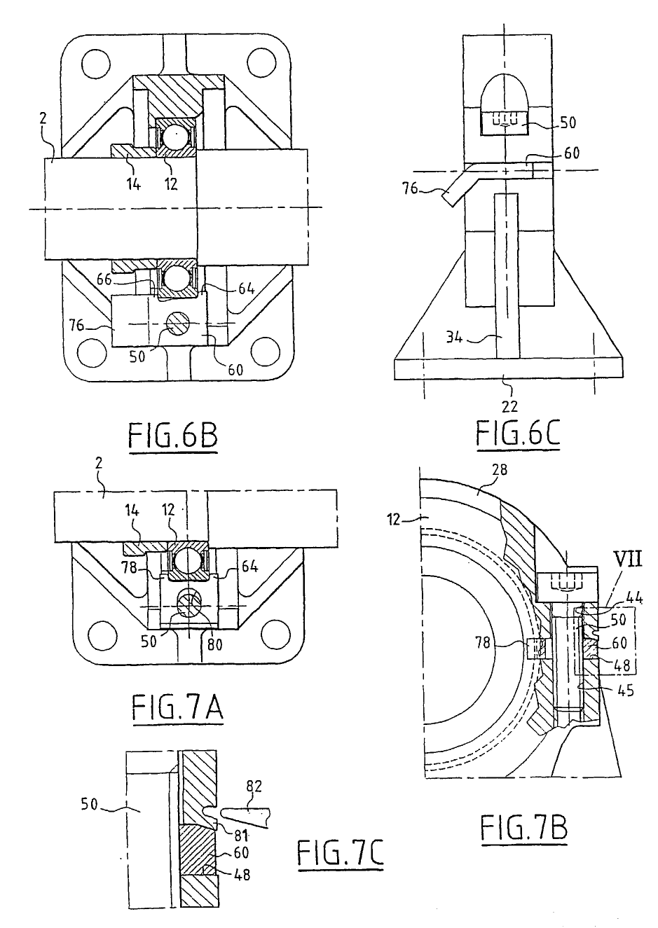

FIG. 6A is a view similar to FIG. 4A, but of another alternative form of wedge;

FIGS. 6B and 6C are views respectively similar to FIGS. 5E and 4B, but of an alternative form of embodiment of a bearing block according to the invention using the wedge of FIG. 6A;

finally, FIGS. 7A, 7B and 7C illustrate another embodiment of a bearing block according to the invention, FIG. 7A being similar to the lower half-view of FIG. 6B, FIG. 7B being similar to part of FIG. 3, and FIG. 7C being an enlarged view of the detail labeled VII in FIG. 7B.

FIG. 1 depicts a joint 1 connecting a shaft 2 and a shaft 4. The shaft 2 is, for example, a transverse half-shaft and the shaft 4 is the stub axle of a driven front wheel of a motor vehicle.

The joint 1 comprises a boot 6 one end of which is fixed to the shaft 4 and the other end of which is fixed to a female element 8 of the joint secured to the shaft 2. This element 8 is formed integrally with and centered on the axis of the shaft 2, forming a shoulder 9 with respect to the shaft 2. This element 8 forms the body of the joint 1 and is commonly known as the bell housing.

The joint 1 depicted is a tripot joint, comprising three journals 10, just one of which is visible in section in FIG. 1. The inside of the joint 1 is not depicted in detail.

The shaft 2 is provided with a rolling bearing 12, coaxial with the shaft 2 and in abutment against the shoulder 9 via its inner race 13, which is held against the shoulder by a race 14 fixed to the shaft.

The shaft 2 and the rolling bearing 12 are supported by a one-piece cast iron bearing block 20 comprising a fixing sole 22 parallel to the axis of the shaft 2. This fixing sole 22 is fixed to the engine block, not depicted, by means of four fixing points 24 each taking a fixing screw. The number and locations of these points 24 are dependent on the characteristics of the element to which the sole 22 is fixed, and on the intensity of the mechanical stresses to which the bearing block 20 will be subjected.

The bearing block 20 comprises a tubular part 28 which surmounts the sole 22 and which forms a single clamping jaw internally delimiting a bore 26 that is roughly cylindrical and coaxial with the shaft 2. This bore 26 receives the rolling bearing 12 mounted on the shaft 2 in such a way that the bearing block 20 holds the rolling bearing 12, the shaft 2 and the bell housing 8 radially.

The jaw 28 is supported by the fixing sole 22 by means of several reinforcements or ribs: inclined end reinforcements 30, 31, 32 and 33 which extend from each end edge face of the jaw 28, lateral radial reinforcements 34 and 35 extending in the plane perpendicular to the sole 22 situated mid-way along the jaw 28, and a radial reinforcement 36 delimited in the same plane between the reinforcements 30 and 31.

The jaw 28 has an end neck 40 projecting radially toward the inside of the bore 26, at one end thereof.

The jaw 28 externally delimits a recess 42 extended in succession by a roughly cylindrical bored hole 44 and by a tapped hole 45 roughly coaxial with the bored hole 44. These coaxial holes 44 and 45 pass through the jaw 28 along a chord situated tangentially with respect to the bore 26, and do not communicate with the bore 26.

As depicted in FIG. 2, the part of the jaw in which the recess 42 and the holes 44 and 45 are made loses its circular external profile in cross section, because of an outgrowth of material 46. This outgrowth 46 has a roughly rectangular outwardly directed profile in continuity with the rest of the profile of the jaw 28.

In FIG. 2, the periphery of the bore 26 is open at an open point A, forming a slot 48 roughly perpendicular to the axis of the holes 44 and 45. The tapped hole 45 is entirely situated below the slot 48. This slot is made from the point A by a very fine cut in the tubular piece 28 at the region of the material line between the bore 26 and the exterior surface of the outgrowth 46, this slot being directed transversely to the axis of the holes 44 and 45. Such a cut, of the order of a few tenths of a millimeter, requires a small loss of material and is made, for example using a laser.

The holes 44 and 45 take a hexagon-head screw 50, from the recess 42.

The bearing block 20 is mounted as follows.

The sole 22 of the bearing block is first of all fixed to the lower part of the engine block.

This fixing is performed using several fixing members such as screws, the respective shanks of which are passed through one of the perforations 24.

The shaft 2, onto which the rolling bearing 12 has already been slipped as far as the shoulder 9 and onto which the race 14 has been slipped, is then slipped into the bore 26. Given that one end of the shaft consists of the bell housing 8, the outside diameter of which is greater than that of the bore 26, there is only one conceivable direction in which the shaft can be slipped through the bore 26. This direction of slipping is the one perpendicular to the plane of FIG. 2 pointing toward the reader, and from right to left in FIG. 1.

The shaft is thus slipped through the bore 26 until the inner race of the bearing 12 is held axially on one side by the shoulder 9 and until, on the other side, its outer race is held axially by the neck 40 of the jaw 28.

Unless this has been done beforehand, the clamping screw 50 is introduced into the coaxial holes 44 and 45. This screw 50 is then tightened using an appropriate tool so that the antagonistic edges of the slot 48 are brought into tight contact. The intensity of the clamping is then just sufficient for the shaft 2 and the rolling bearing 12 to be held in place axially without there being a risk of the rolling bearing 12 locking up.

The bearing block 20 according to the invention thus allows quick and easy mounting of the shaft 2 and of the rolling bearing 12 because these are slipped effortlessly through the bore 26. The bearing block is then clamped at a single point, the intensity of the clamping is adjusted with high precision by simply dimensioning the bore 26 and the slot 48.

Aside from these advantages, the bearing block according to the invention has a minimum number of parts. Furthermore, its one-piece structure allows it easily to be preformed by pouring, which gives good geometric precision, and low production cost. The bearing block can be made of materials of varying natures, allowing lightness of weight with sufficient mechanical strength in a given context of mechanical stresses.

FIG. 3 illustrates another embodiment of a bearing block according to the invention, differing from the one depicted in FIG. 2 as follows.

The slot 48, which is far wider than the previous one, has at its inner end a thin leaf of material 54 which connects its two edges. In addition, the diameter of the bore 26 is exactly the diameter needed to clamp the rolling bearing 12.

The bearing block in this embodiment is mounted in an identical way to the previous embodiment except that, in order to slip the shaft in, the slot 48 is opened up slightly by the brittle fracture of the leaf of material 54, which entails making at least this leaf out of a material which has a brittle fracture domain, such as cast iron or a steel that has a ductile-brittle transition. The broken faces then meet up again elastically, which precisely restores the diameter of the bore 26.

One non-depicted alternative form of this embodiment consists in providing the fine leaf 54 near the outer surface of the outgrowth 46. Mounting a bearing block according to this alternative form is done in the same way as in the previous one.

FIG. 4C illustrates a third embodiment of a bearing block according to the invention, differing from the one depicted in FIG. 3 as follows.

The leaf 54 is omitted, and a wedge 60, the thickness of which is slightly smaller than the height of the slot 48, is arranged between the edges of this slot. The wedge 60 is depicted alone in FIG. 4A.

The wedge 60 delimits, roughly at its middle, an orifice 62. This orifice 62 is bored and of a diameter roughly equal to the diameters of the holes 44 and 45. When the wedge is mounted between the edges of the recess 48, as depicted in FIGS. 4B and 4C, the holes 44 and 45 and the orifice 62 in the wedge 60 are roughly coaxial.

The wedge 60 is of roughly parallelepipedal shape and has a projection 64 in the continuation of its side opposite the one closest to the end neck 40 of the jaw 28.

The bearing block according to this embodiment is mounted in a way which differs from the previous way only as follows.

Mounting is performed as before, but without the bearing having the wedge 60.

Once the shaft 2 and the rolling bearing 12 have been positioned in the bore 26 of the bearing block, and before the clamping screw 50 is introduced into the hole 44, the wedge 60 is inserted into the slot 48 so that the projection 64 becomes positioned against the outer race of the rolling bearing 12, on the opposite side to the neck 40. The projection 64 thus holds this race against the neck 40.

The clamping screw 50 is then introduced from the recess 42 through the hole 44; the screw 50 passes through the wedge 60 via the orifice 62 arranged in the continuation of the holes 44 and 45. The screw 50 is tightened as before.

This embodiment has the advantage of not requiring cutting means that remove small amounts of material and neither does it restrict the choice of material from which the bearing block can be made to those which have a brittle fracture domain.

FIG. 5A depicts a first alternative form of the wedge 60, differing from the previous elemental embodiment as follows.

The wedge 60 comprises a second projection 66 directed in roughly the same direction as the projection 64 but in the continuation of the opposite side to the one delimiting the projection 64 in its continuation.

The edge 68 of the wedge extending from the projection 64 as far as the projection 66 does not, in section on the plane perpendicular to the axis of the orifice 62, have a straight profile. On the contrary, this edge 68 has a first part 71 which extends from the projection 64 with a straight profile perpendicular to the projection 64, and then a second part 72 which extends in continuation of the part 71 with a straight profile converging toward the axis of the orifice 62, and finally a third part 73 which extends in the continuation of the part 72 as far as the projection 66 with a curved profile which is concave with respect to the inside of the wedge 60.

The mounting of a bearing block comprising the wedge 60 according to this alternative form and which has just been described is depicted in four successive stages of operation in FIGS. 5B, 5C, 5D and 5E.

As before, having fixed the sole of the bearing block and fixed the rolling bearing 12 to the shaft 2 against the shoulder 9, the shaft 2 is introduced in the same direction of slipping as described above, indicated in FIGS. 5B to 5E by the arrow S.

Before slipping the shaft 2 into the bore 26, or just before the rolling bearing 12 comes close to the bore 26, the wedge 60 is positioned as depicted in FIG. 5B, that is to say with the part 72 of its edge 68 roughly parallel to the axis of the shaft 2. The clamping screw 50 is introduced without being tightened into the holes 44 and 45 and through the orifice 62.

The straight progression of the shaft 2 in the direction of the arrow S brings the exterior periphery of the rolling bearing 12 flush with, on the one hand, the edge of the bore 26 and, on the other hand, the projection 64 at the end surface furthest toward the inside of the bore 26. This stage in the proceedings is depicted in FIG. 5C.

Still continuing to slip the shaft 2 in, the outer race of the rolling bearing 12 continues to lie flush with the periphery of the bore 26 and slides along the part 72 of the edge 68 of the wedge 60 as depicted in FIG. 5D. The outer race of the rolling bearing then comes into contact with the projection 66 of the wedge 60, having then moved fully past the projection 64.

The rolling bearing 12 transmits to the projection 66 a thrusting force directed roughly in the direction of slipping S. Under the effect of this force, the wedge 60 pivots about the axis of the orifice 62, both allowing the shaft 2, and therefore the rolling bearing 12, to continue their progress, and bringing the part 71 of the edge 68 into contact with the exterior periphery of the rolling bearing 12. The projection 64 thus finds itself arranged against the outer race of the rolling bearing 12 as depicted in FIG. 5E. The projection 64 clearly forms an axial stop for the outer race of the rolling bearing 12, opposing its withdrawal. In this state, the end neck 40 of the jaw 28 is in contact with the outer race of the rolling bearing 12, as before. The end neck 40 clearly constitutes an axial slipping-in stop for this outer race, collaborating with the projection 66 of the wedge 60.

The clamping screw 50 is then tightened so that the wedge 60 is prevented from effecting any pivoting movement.

The bearing block provided with such a wedge 60 has the advantage of being easy to mount using an automated machine. What happens is that, by positioning the wedge in its initial position as depicted in FIG. 5B, for example using slight tightening of the screw 50 involving no significant reduction in the diameter of the bore 26, the shaft 2 can be slipped in by simple straight guidance in the direction of the arrow S. Whilst the wedge 60 is in the final position as depicted in FIG. 5E, tightening the screw 50 to prevent the rotation of the wedge 60 is enough to oppose the withdrawal of the rolling bearing 12, and this makes it possible to reduce with precision the diameter of the bore 26.

FIGS. 6A, 6B and 6C illustrate a second alternative form of the wedge 60, which differs from the previous one only as follows.

In FIG. 6A, which depicts the wedge 60 alone before it is mounted, the wedge comprises a lateral tab 76 arranged on the side extended by the projection 66. This tab 76 is of a thickness roughly equal to that of the rest of the wedge 60 and extends the wedge 60 continuously in the same plane.

The bearing block according to the invention comprising such a wedge is mounted in an identical way to the previous one, the only difference being that the wedge 60, once it has been pivoted to bring it into its final position, is prevented from any further pivoting movement not by the tightening of the screw 50 but by the folding down of the tab 76 in a direction parallel to the axis of the orifice 62 of the wedge, as depicted in FIGS. 6B and 6C. Any subsequent pivoting of the wedge 60 to allow the rolling bearing 12 to be withdrawn is made impossible in this way because the outgrowth 46 opposes the path that the tab 76 would have to take once folded down.

FIGS. 7A, 7B and 7C depict a third alternative form of the wedge 60, differing from the previous embodiment in FIG. 4A only as follows.

The wedge 60 comprises, in addition to the projection 64, a projection 78 symmetric with the projection 64, arranged in the continuation of the opposite side whose continuation delimits the projection 64.

The wedge 60 delimits, roughly at its center, an oblong orifice 80 parallel to the projections 60 and 64, the short diameter of which is roughly equal to the diameters of the holes 44 and 45 in the bearing block.

The bearing block according to the invention provided with such a wedge 60 is mounted in an identical way to the bearing block provided with a wedge 60 according to the embodiment of FIG. 4A, except for the following differences.

The wedge 60 is arranged in the slot 48, the screw 50 being slipped into the holes 44 and 45 and the orifice 80. Before and during the slipping of the shaft 2 through the bore 26, the wedge 60 is held in the slot 48 in a first position furthest toward the outside of the bearing block by means of the significant clearance allowed by the oblong shape of the orifice 80.

Then, once the shaft 2 and the rolling bearing 12 have been positioned with respect to the bore 26, the wedge 60 is brought by translation toward the inside of the bearing block into a second position depicted in FIG. 7A such that its two projections 64 and 78 extend one on each side of the rolling bearing 12.

The projection 78 thus performs practically the same axial-retention function as the projection 66 in the previous alternative forms of the wedge 60.

Once the wedge 60 has been brought into this second position, a subsequent translational movement thereof is prevented by the tightening of the screw 50 or, alternatively, and as depicted in FIG. 7C, by the plastic deformation of an edge of the slot 48. A bulge of material 80 is thus formed in crushed contact along the wedge 60 at the opposite edge to the one which has the projections 64 and 78. This bulge 80 is produced by means of an appropriate tool 82, of the punch type, and keeps the wedge 60 in the desired position.

An alternative form, not depicted, suited to holding in place a wedge 60 which has been moved in translation as before, consists in producing, on at least one edge of the slot 48, a projection directed toward the inside of this slot so that it does not impede the introduction of the wedge but, once the jaw has been clamped, opposes any subsequent movement of withdrawal in translation.

1. A bearing block intended to support a mechanical transmission member comprising a rolling bearing (12), of the type comprising a fixing sole (22) and forming a bore (26) for supporting the rolling bearing, roughly coaxial with the rolling bearing, and a member (50) for clamping the bearing block onto the rolling bearing, the bore (26) being formed by a clamping jaw (28) of one piece which on its periphery has a single open location (A), characterized in that the open location (A) of the jaw has a slot (48) parallel to the axis of the rolling bearing (12) and provided with a wedge (60) of a thickness roughly equal to that of the slot (48), this wedge having an orifice (62; 80) for the passage of the clamping member (50).

2. The bearing block as claimed in claim 1, characterized in that it comprises a single member (50) for clamping the jaw (28), this member being situated in the region of the open location (A).

3. The bearing block as claimed in claim 2, characterized in that the clamping member (50) extends roughly tangentially with respect to the bore (26).

4. The bearing block as claimed in one of the preceding claims, characterized in that the clamping jaw comprises a circumferential neck (40) projecting radially toward the inside of the bore (26) and forming an axial slipping-in stop for the rolling bearing (12).

5. The bearing block as claimed in one of the preceding claims, characterized in that the open location (A) of the jaw comprises a leaf of material (54) that can undergo brittle fracture.

6. The bearing block as claimed in one of the preceding claims, characterized in that the wedge (60) comprises a projection (64) directed toward the axis of the bore (26) and forming a stop which opposes the withdrawal of the rolling bearing (12).

7. The bearing block as claimed in claim 6, characterized in that the wedge (60) is brought from an initial standby position to a final position of retaining the rolling bearing (12) as the rolling bearing is slipped through the bore (26).

8. The bearing block as claimed in claim 7, characterized in that holding means (50; 76; 80) hold the wedge (60) in its final position secured to the jaw (28).

9. The bearing block as claimed in claim 8, characterized in that the wedge (60) is held in its final position by the tightening of the clamping member (50).

10. The bearing block as claimed in claim 8, characterized in that the wedge (60) comprises a foldable tab (76), the folding-down of which holds the wedge (60) in its final position.

11. The bearing block as claimed in claim 8, characterized in that an edge of the slot (58) forms an integral retention device (80) holding the wedge (60) in its final position.

12. The bearing block as claimed in one of claims 7 to 11, characterized in that the wedge (60) pivots about the axis of its orifice (62) from its initial position to its final position and in that the edge (68) of the wedge (60) comprising the projection (64) comprises, in succession, working away from the projection (64), a first surface (71) arranged roughly parallel to the axis of the rolling bearing (12) when the wedge (60) is in its final position, a second surface (72) arranged roughly parallel to the same axis when the wedge is in its initial position, and a second projection (66).

13. The bearing block as claimed in one of claims 7 to 11, characterized in that the wedge (60) can be moved in a translational movement directed radially toward the bore (26) from its initial position to its final position and in that the orifice (80) of the wedge (60) is of oblong shape.
